(19) United States
(12) Patent Application Publication
(10) Pub. No.: US 2005/0199018 A1
(43) Pub. Date: Sep. 15, 2005

(54) Cable lock assembly

(76) Inventors: Patrick Chen, Taichung City (TW); Kurt Kemppainen, Morgan Hill, CA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 11/045,277

(22) Filed: Jan. 31, 2005

(30) Foreign Application Priority Data
Mar. 9, 2004 (TW) 093203571

(51) Int. Cl. E05B 73/00

(52) U.S. Cl. 70/18; 70/58

(57) ABSTRACT

A lock assembly comprises a cable with a lock at one end of the cable and a connector is movably secured to the cable. The connector can be connected to the lock when in locked status. The connector has an operation member movably received in a recess defined in a top of the connector and a top end of the operation member exposed outside of the connector. The operation member has a passage which has a larger diameter than that of the through hole in the connector. A spring is received in the connector and biases the bottom of the operation member toward the cable to fix the connector at a desired position on the cable.

### FIELD OF THE INVENTION

The present invention relates to a cable lock having a connector movably secured to the cable so as to be connected to the lock at desired position of the cable.

### BACKGROUND OF THE INVENTION

A conventional lock 60 for bicycle is disclosed in FIG. 12, and generally includes a U-shaped frame 61 and a bar 62 is pivotably connected to a first end of the U-shaped frame 61, a lock 63 is connected to a second end of the U-shaped frame 61. The bar 62 can be connected to the lock 63 when in locked status. This type of lock 60 is limited by the fixed length of the U-shaped frame 61. Sometimes, it cannot lock the bicycle to a fixed structure such as a column with larger diameter. FIG. 13 shows another conventional lock assembly 70 which includes a cable 71 and two loops 72 are connected on two ends of the cable 71, a lock piece 73 locks the tow loops 72 together. FIG. 14 shows yet another conventional lock assembly 700 that includes a cable 710 and a lock 74 is connected to one end of the cable 710, a connector 75 is connected to the other end of the cable 710. The connector 75 can be connected to the lock 74. All the conventional lock assemblies are used by connecting one end to the other end of the cable. The way of use of the lock assemblies is not adjustable.

The present invention intends to provide a lock assembly that has a connector movably secured to the cable so that there are several ways to use the lock assembly to meet different requirements.

### SUMMARY OF THE INVENTION

The present invention relates to lock assembly which comprises a cable and a lock is connected at one end of the cable and a connector is movably secured to the cable. The connector has a through hole defined therethrough and the cable extends through the through hole. An insertion extends from the connector so as to be connected with the lock. The connector has an operation member movably received in a recess defined in a top of the connector and a top end of the operation member is exposed outside of the connector. The operation member has a passage which has a larger diameter than that of the through hole in the connector. A control device for positioning the operation member in the connector pushes the connector to let the cable be secured between the connector and the operation member.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the cable lock of the present invention;

FIG. 2A is a cross sectional view to show the connector, the operation member and the cable which is secured by the spring pushing the operation member;

FIG. 2B shows that the operation member is pushed downward to allow the connector to be moved freely;

FIG. 3 shows another embodiment of the operation member and the connector;

FIG. 4A is a cross sectional view to show the connector, the operation member and the cable in FIG. 3, wherein the cable is secured by the spring pushing the operation member;

FIG. 4B shows that the operation member is pushed downward to allow the connector to be moved freely;

FIG. 5 shows the connector may have no operation member installed therein;

FIG. 5A is a cross sectional view to show the cable can be freely moved relative to the connector in FIG. 5;

FIG. 6 shows another embodiment of the cable lock of the present invention;

FIG. 7 shows yet another embodiment of the cable lock of the present invention;

FIG. 8 shows that the lock can be a combination lock;

FIG. 9 shows that the lock is connected with a loop;

FIG. 9A shows that the lock is hooked to the cable;

FIG. 10 shows a bicycle is locked by the cable lock with a fixed structure;

FIG. 11 shows the cable locks of the present invention are used for blocking an entrance;

FIG. 12 shows a conventional bicycle lock;

FIG. 13 shows another conventional bicycle lock, and

FIG. 14 shows yet another conventional bicycle lock.

### DETAILED DESCRIPTION OF THE PREFERRED EMBODIMENT

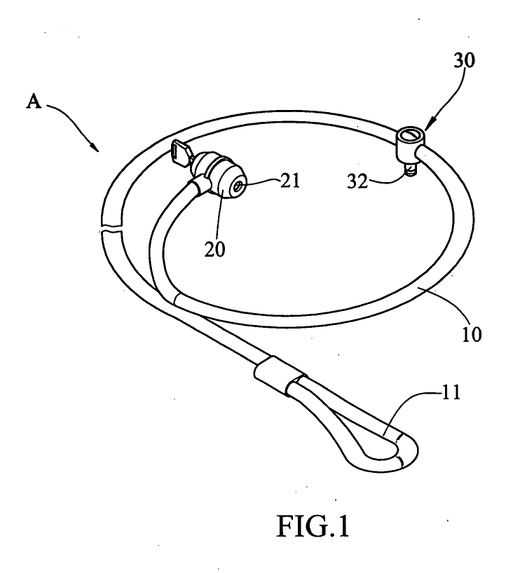

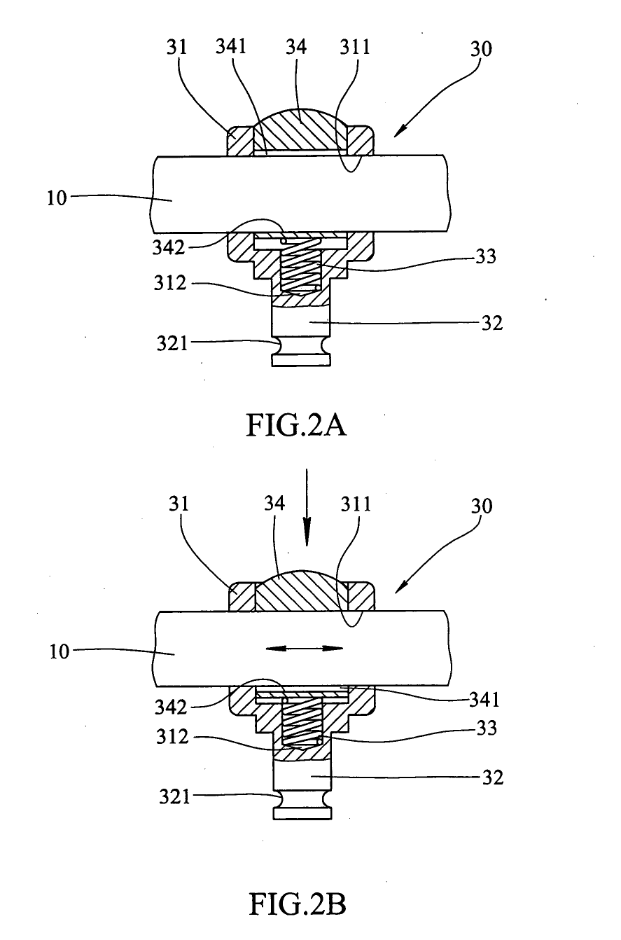

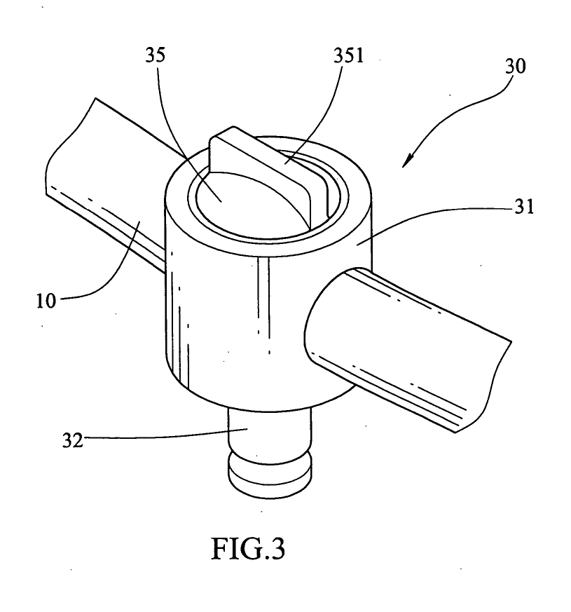

Referring to FIGS. 1 and 2A, the cable lock “A” of the present invention comprises a cable 10 having a lock 20 at one end of the cable 10 and a connector 30 is movably secured to the cable 10. The connector 30 has an insertion 32 extending therefrom and a groove 321 is defined in an outer periphery of the insertion 32. The insertion 32 can be inserted into a hole 21 in the lock 20 to be locked with the lock 20. A through hole 311 is defined through the body 31 of the connector 30 such that the cable 10 extends through the through hole 311. An operation member 34 is movably received in a recess defined in a top of the connector 30 and a top end of the operation member 34 is exposed outside of the connector 30 so that the users can push the operation member 34 downward which will be described later. The operation member 34 has a passage 341 which has a larger diameter than that of the through hole 311 in the connector 30 and the cable 10 extends through the passage 341.

A control device for positioning the operation member 34 in the connector 30 is a spring 33 which is received in a chamber 312 in the connector 30. The spring 33 biases a bottom of the control member 34 toward the cable 10 extending through the passage 341 so that the cable 10 is pushed against the inner periphery of the through hole 311 by an inner periphery 342 of the passage 341. This status limits the connector 30 from moving along the cable 10. As shown in FIG. 2B, the user may push the operation member 34 downward to remove the force from the spring 33 so that the cable 10 is not biased by the inner periphery 342 of the passage 341 and the connector 30 can be moved freely along the cable 10.

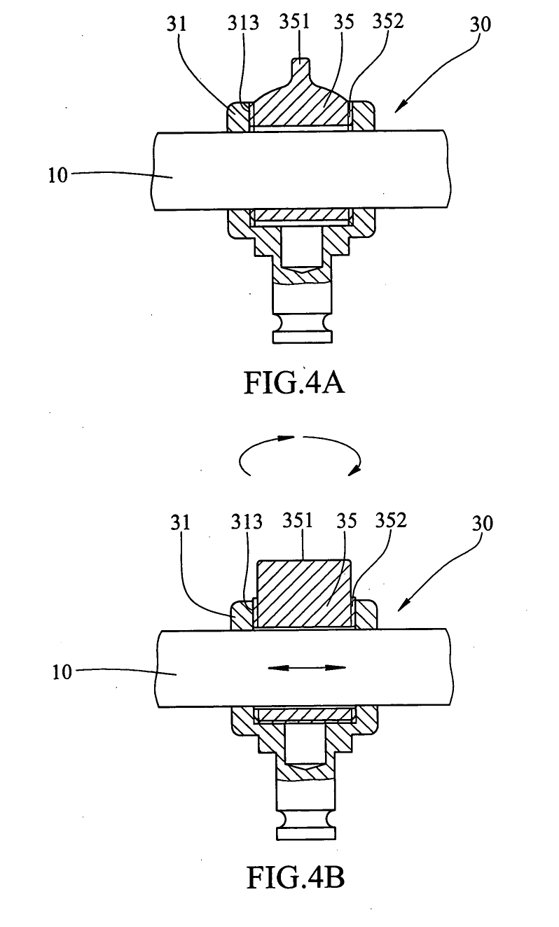

Referring to FIGS. 3, 4A and 4B, another embodiment of the present invention is that the control device includes a threaded outer periphery 352 defined in the operation member 35 and a threaded inner periphery 313 is defined in an inner periphery of the recess in the connector 30. The threaded inner periphery 313 is threadedly connected to the threaded outer periphery 352 of the operation member 35. A ridge 351 extends form the top end of the operation member 35 so that the user may hold the ridge 351 and rotate the operation member 35 to position the operation member 35 at desired position. In this embodiment, the spring will not be necessary.

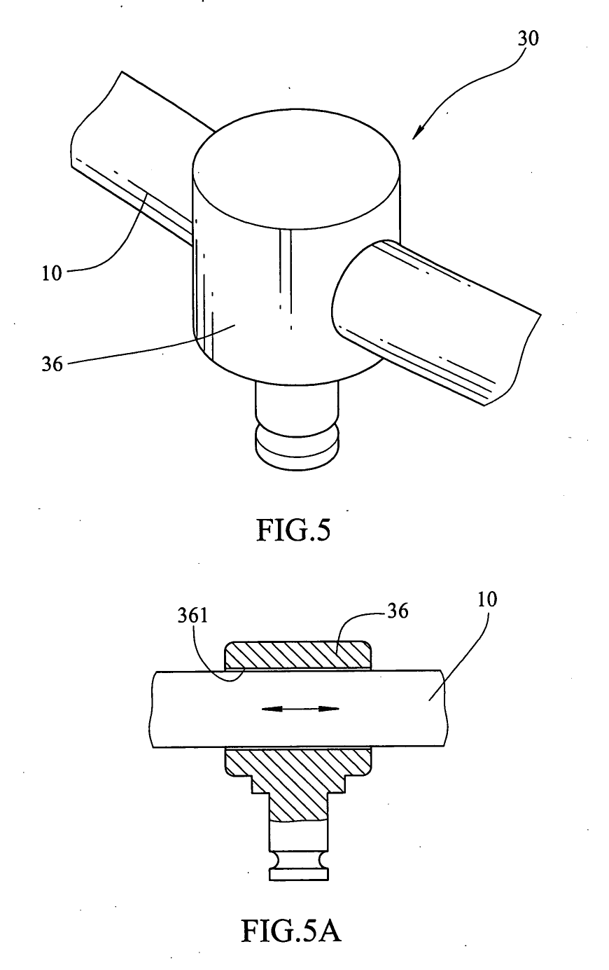

FIGS. 5 and 5A show that the connector 30 can simply be a movable member on the cable 10 and includes a through hole 361 through which the cable extends.

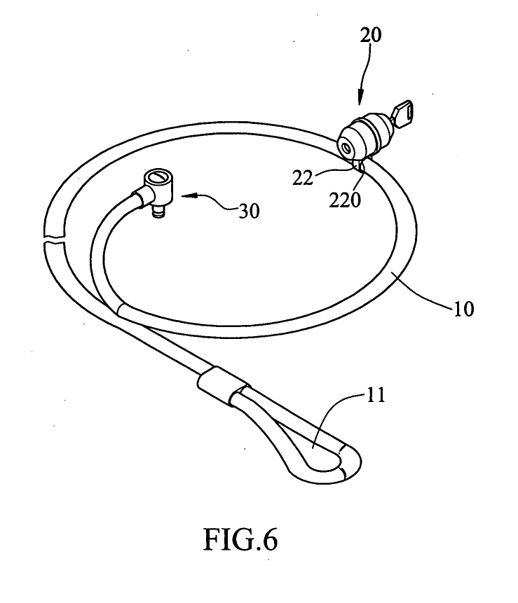

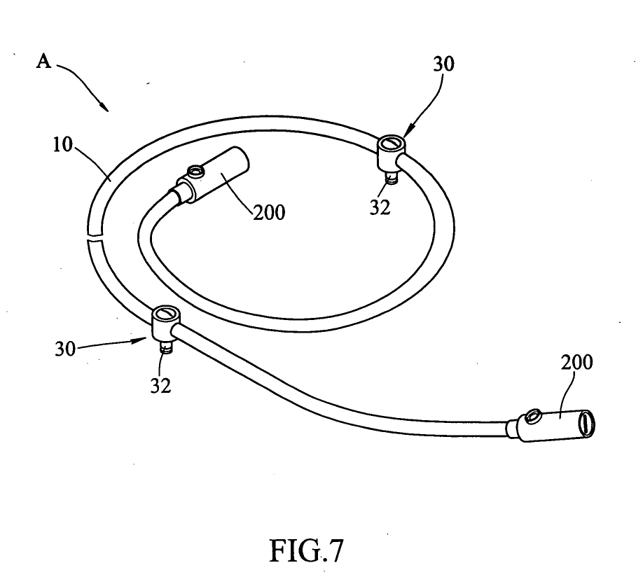

FIG. 6 shows that the connector 30 is fixed at one end of the cable 10 and a loop 11 is fixed to the other end of the cable 10. The lock 20 is fixed to a collar 22 which has a hole 220 through which the cable 10 is extended. The lock 20 is moved to a desired position to be connected with the connector 30. FIG. 7 shows yet another embodiment, wherein two locks 200 are respectively connected to two ends of the cable 10 and two connectors 30 are movably secured on the cable 10. This specific arrangement allows the cable lock to be used in different ways.

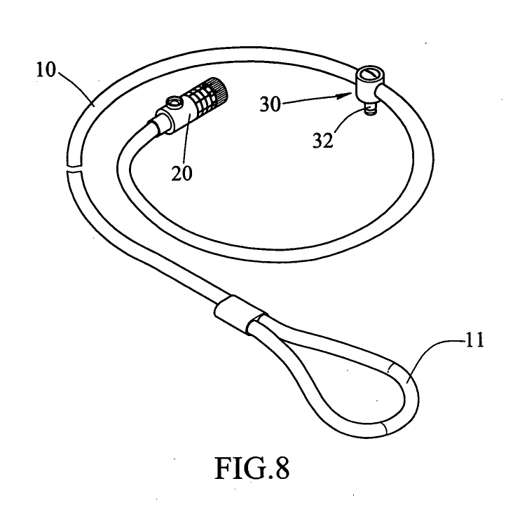

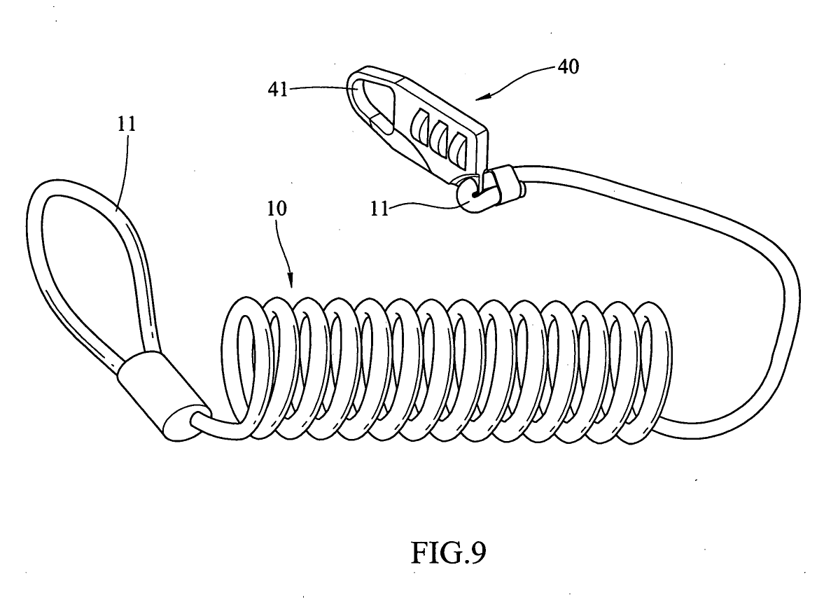

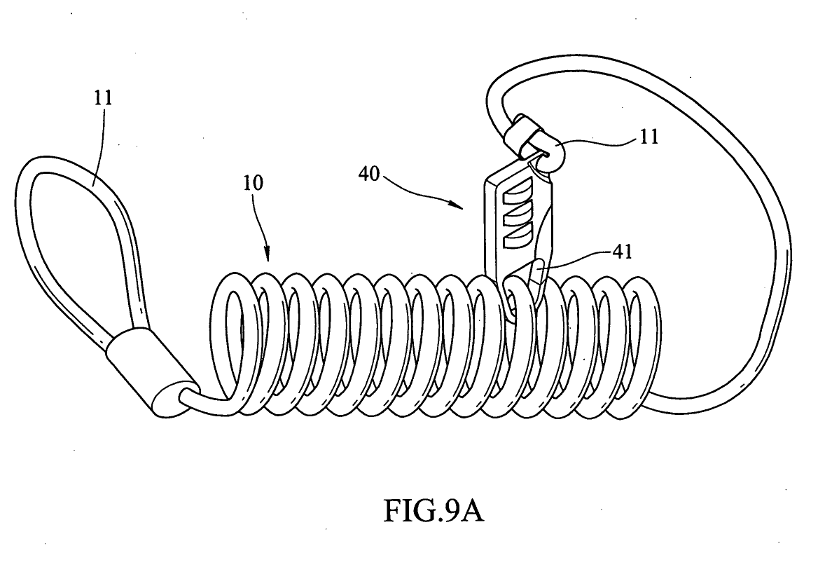

FIG. 8 shows that the lock 20 at one end of the cable 10 can be a combination lock and a loop 11 is connected to the other end of the cable 10. A connector 30 is movably secured to the cable 10.

FIGS. 9 and 9A show that two loops 11 are connected to two ends of the cable 10 and a lock 40 with a hook portion 41 is connected to one of the tow loops 11. The lock 40 can be used to hook at the spiral portion of the cable 10.

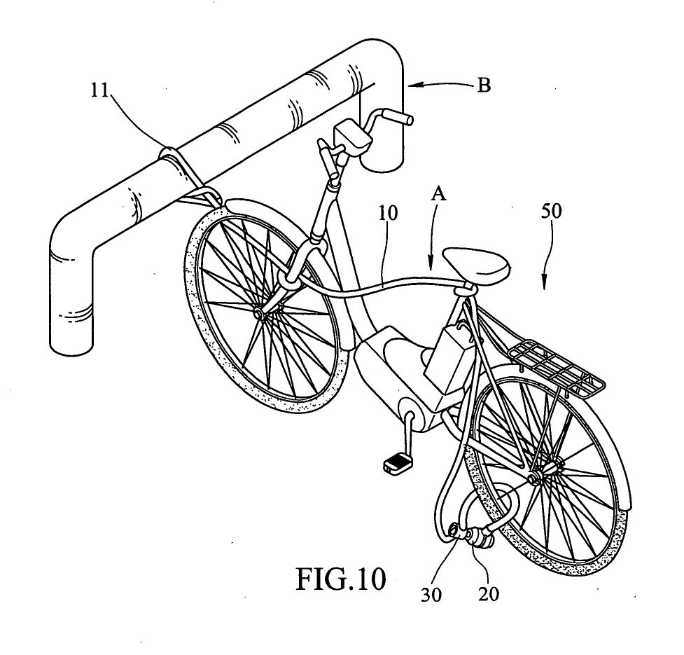

FIG. 10 shows that the cable lock “A” is used to lock the bicycle 50 to a fixed structure “B”. The end with the lock 20 goes around the fixed structure “B” and through the loop 11, and then goes through the front wheel, the front fork, the seat post, and the rear wheel, and is connected with the connector 30. This ensures that all the important parts of the bicycle 50 is combined with the cable lock “A”.

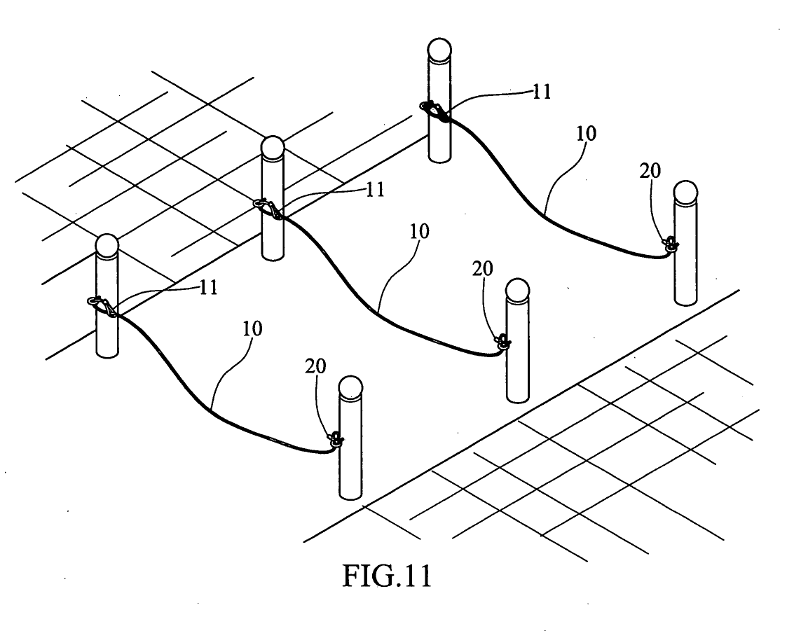

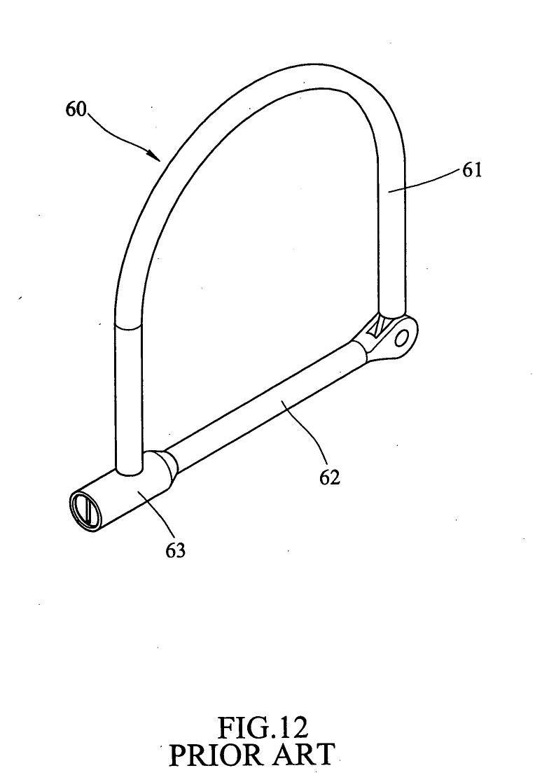

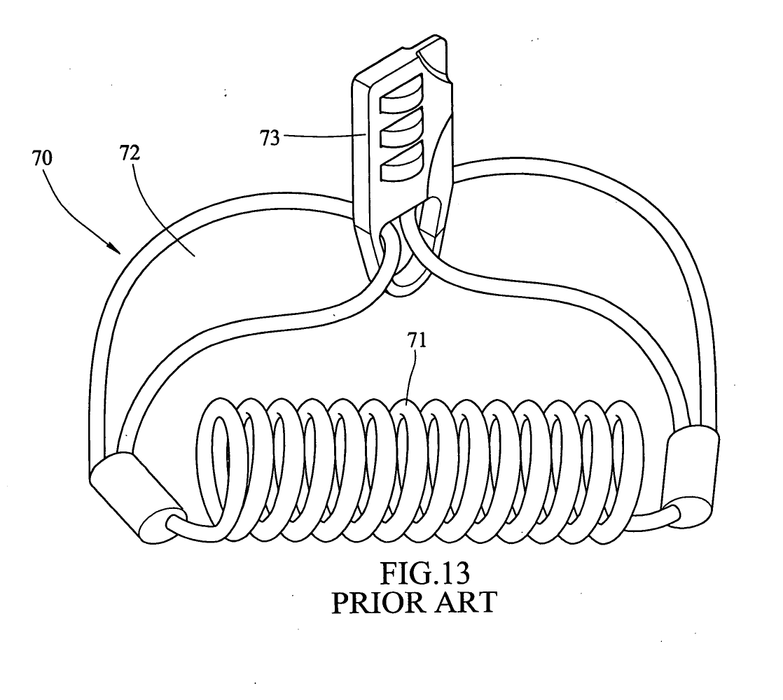

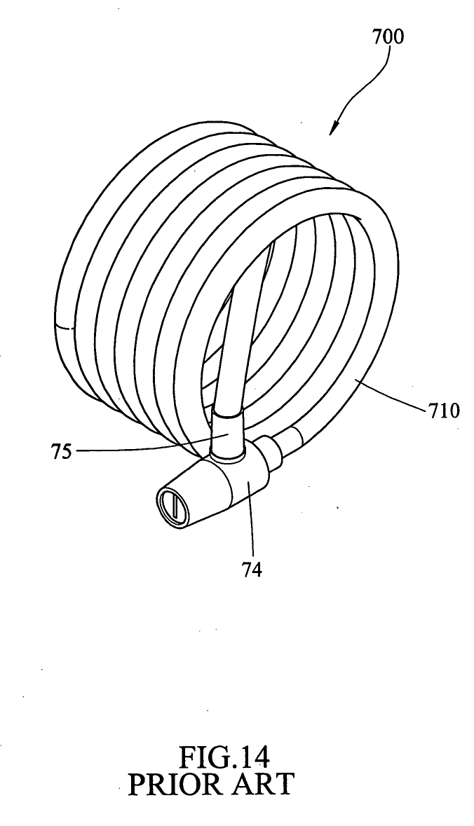

FIG. 11 shows the cable locks are used for blocking an entrance or for separating different paths.

While we have shown and described the embodiment in accordance with the present invention, it should be clear to those skilled in the art that further embodiments may be made without departing from the scope of the present invention.

1. A lock assembly comprising:
a cable having a lock at one end of the cable and a connector movably secured to the cable, the connector having a through hole defined therethrough and an insertion extending from the connector, the insertion being capable of connection with the lock, the connector having an operation member movably received in a recess defined in a top of the connector, a top end of the operation member being exposed outside of the connector, the operation member having a passage which has a larger diameter than that of the through hole in the connector, and
a control device for positioning the operation member in the connector.

2. The assembly as claimed in claim 1, wherein control device is a spring received in a chamber in the connector and biases a bottom of the control member toward the cable extending through the passage.

3. The assembly as claimed in claim 1, wherein the control device includes a threaded outer periphery defined in the operation member and a threaded inner periphery defined in an inner periphery of the recess in the connector, the threaded inner periphery is threadedly connected to the threaded outer periphery of the operation member.

4. The assembly as claimed in claim 2, wherein a ridge extends form the top end of the operation member.

5. The assembly as claimed in claim 1, wherein a loop is connected to the other end of the cable.

6. The assembly as claimed in claim 1, wherein another lock is connected to the other end of the cable.

7. The assembly as claimed in claim 1, wherein the lock is connected with a loop.

8. A lock assembly comprising:
a cable having a connector at one end of the cable and a lock movably secured to the cable, the connector having a through hole defined therethrough and an insertion extending from the connector, the insertion being capable of connection with the lock, the connector having an operation member movably received in a recess defined in a top of the connector, a top end of the operation member being exposed outside of the connector, the operation member having a passage which has a larger diameter than that of the through hole in the connector, and
a control device for positioning the operation member in the connector.

9. The assembly as claimed in claim 8, wherein the lock is connected to a collar which is movably mounted to the cable.

10. The assembly as claimed in claim 1, wherein control device is a spring received in a chamber in the connector and biases a bottom of the control member toward the cable extending through the passage.

11. The assembly as claimed in claim 1, wherein the control device includes a threaded outer periphery defined in the operation member and a threaded inner periphery defined in an inner periphery of the recess in the connector, the threaded inner periphery is threadedly connected to the threaded outer periphery of the operation member.

12. The assembly as claimed in claim 11, wherein a ridge extends form the top end of the operation member.

13. The assembly as claimed in claim 8, wherein a loop is connected to the other end of the cable.

14. The assembly as claimed in claim 8, wherein another lock is connected to the other end of the cable.

15. The assembly as claimed in claim 8, wherein the lock is connected with a loop.
